(19) United States
(12) Patent Application Publication
(10) Pub. No.: US 2024/0387920 A1
(43) Pub. Date: Nov. 21, 2024

(54) CASE SIDE WALL OF BATTERY CASE

(71) Applicant: TOYOTA JIDOSHA KABUSHIKI KAISHA, Toyota-shi (JP)

(72) Inventors: Katsunori HIGASHIHARA, Toyota-shi (JP); Takahiro FUKUOKA, Toyota-shi (JP); Haruhiko YAMAMOTO, Miyoshi-shi (JP); Hina KATO, Toyota-shi (JP)

(73) Assignee: TOYOTA JIDOSHA KABUSHIKI KAISHA, Toyota-shi (JP)

(21) Appl. No.: 18/631,404

(22) Filed: Apr. 10, 2024

(30) Foreign Application Priority Data
May 17, 2023 (JP) 2023-081442

(51) Int. Cl. H01M 50/24; B60L 50/60; H01M 50/224; H01M 50/249; H01M 50/271

(52) U.S. Cl. CPC H01M 50/24; B60L 50/60; H01M 50/224; H01M 50/249; H01M 50/271; H01M 2220/20

(57) ABSTRACT

The case side wall and the upper cover 24 are sealingly connected at the upper wall. The case side wall and the lower cover are sealingly connected by an inner flange. A first member of one steel plate of the case side wall forms a portion of the upper wall that is sealingly coupled to the upper cover, an inner flange, and an inner wall in one piece seamlessly and without holes. The inner wall serves as a waterproof wall, and even if water enters the tubular portion of the case side wall, it is possible to prevent water from entering into the battery accommodating space of the battery case.

### CROSS-REFERENCE TO RELATED APPLICATION

This application claims priority to Japanese Patent Application No. 2023-081442 filed on May 17, 2023, incorporated herein by reference in its entirety.

### BACKGROUND

### 1. Technical Field

The disclosure relates to a battery case that houses a battery that is an in-vehicle battery, and more particularly relates to a structure of a case side wall.

### 2. Description of Related Art

There is known a vehicle, in which an electric motor serving as a driving prime mover, and a battery that supplies electric power to this electric motor, are installed. The battery is housed in a battery case that is watertight. Japanese Unexamined Patent Application Publication No. 2022-42851 (JP 2022-42851 A) describes a battery case (battery case 100) in which a bathtub-shaped tray (120) is disposed on an inner side of a square window-sash-like frame (110), and a battery (battery 30) is housed in a recessed part of the tray (120). A top cover (130) is disposed so as to cover an upper face of the tray (120), so that inside of the tray (120) is sealed, and waterproof property is ensured. Note that the member names and signs in the parentheses above are those used in JP 2022-42851 A, and do not correspond to the member names and signs used in the description of the embodiment of the present application.

### SUMMARY

In the above JP 2022-42851 A, a peripheral wall of the tray and the frame are disposed around the battery housed in the battery case, and thus a plurality of members is disposed redundantly. Accordingly, there is much waste of material, and space for installing the battery is reduced.

It is an object of the disclosure to ensure waterproof property while reducing the number of members making up a battery case.

A case side wall of a battery case of an in-vehicle battery according to the disclosure includes
a tubular portion with a closed cross-sectional structure, made up of an upper wall, an inner wall, an outer wall, and a lower wall, and
an inner flange that is disposed along a longitudinal direction of the tubular portion and is erected on the inner wall, and that is sealingly joined to a lower cover of the battery case.
The case side wall includes a first member made of one steel plate that integrally and seamlessly makes up a portion of the upper wall that is sealingly joined to an upper cover of the battery case, the inner flange, and a portion from an upper edge of the inner wall to an erect portion of the inner flange, without a hole.

The case side wall is formed seamlessly and without holes, from a single steel plate, between the portion sealingly joined to the upper cover and an inner portion sealingly joined to the lower cover, and thus can suppress infiltration of water from the outside.

In the case side wall,
the case side wall may further include an outer flange that is disposed along the longitudinal direction of the tubular portion and is erected at a position between an upper edge and a lower edge of the outer wall, and that is joined to a structure located on a side of the battery case, and
the first member may further make up the outer flange, and a portion of the outer wall from the upper edge to an erected portion of the outer flange.
The case side wall may further include a second member that is made of a steel plate, and that makes up a portion of the outer wall from the erected portion of the outer flange to the lower edge, and the lower wall, and a portion of the second member may overlap with the first member to make up the outer flange together with the first member.

The case side wall can be formed by two members each made of a steel plate.

In the case side wall of the above-described battery case, the inner flange may be erected at a lower edge of the inner wall. Height of internal space of the battery case can be increased.

The case side wall itself of the battery case serves as a watertight wall, and thus infiltration of water to an inner side of the case side wall can be suppressed, without providing a watertight structure on the inner side of the case side wall.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of an electrified vehicle equipped with a battery;

FIG. 2 is a diagram illustrating a schematic configuration of a battery pack, in which the upper cover is removed and the inside is visible;

FIG. 3 is a cross-sectional view of the case side wall and its surrounding configuration;

FIG. 4 is a view showing an aspect of joining the first member and the second member forming the case side wall; and

FIG. 5 is a view showing another aspect of case side wall.

### DETAILED DESCRIPTION OF EMBODIMENTS

Hereinafter, embodiments of the present disclosure will be described with reference to the drawings. In the following description, unless otherwise specified, terms representing relative positions and orientations, such as front, rear, left, right, up, down, etc., represent relative positions and orientations with respect to a vehicle. In addition, a side close to a center line extending in the front-rear direction of the vehicle in the left-right direction (width direction) of the vehicle is referred to as a vehicle width direction inner side, and a far side is referred to as a vehicle width direction outer side. In the drawings, the direction of the arrow FR is forward, the direction of the arrow UP is upward, the direction of the arrow LH is leftward, and the direction of the arrow OUT is outer in the vehicle widthwise direction.

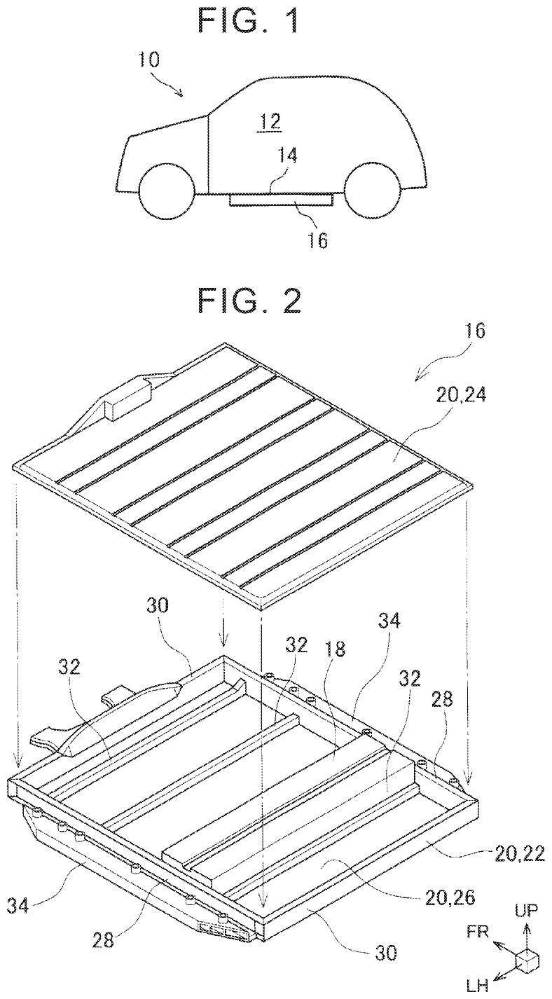

FIG. 1 is a diagram illustrating a schematic configuration of an electrified vehicle 10. Electrified vehicle 10 may be a battery electric vehicle having only an electric motor as a prime mover for driving a vehicle, or may be a hybrid battery electric vehicle including an electric motor and a motor as a prime mover for driving a vehicle. Electrified vehicle 10 is equipped with a battery pack 16 including a battery for supplying electric power to a vehicle-driving electric motor below the floor 14 of the passenger compartment 12.

FIG. 2 is a perspective view illustrating a schematic configuration of the battery pack 16 in a state in which the inside is visible. The battery pack 16 includes a battery stack 18 in which battery cells are stacked, and a battery case 20 that houses the battery stack 18. In FIG. 2, only one battery stack 18 is shown. The battery case 20 includes a frame 22 having a rectangular frame shape, and an upper cover 24 and a lower cover 26 disposed so as to sandwich the frame 22 from above and below. The upper cover 24 and the lower cover 26 are sealingly coupled to the frame 22 at their peripheral edges, and the battery case 20 is sealed. The frame 22, the upper cover 24, and the lower cover 26 define a space for accommodating the battery stack 18.

The frame 22 has left and right case side walls 28 extending along the front-rear direction, and front and rear case end walls 30 extending along the left-right direction. Both ends of the front end and the front case end wall 30 of the left and right case side walls 28 are coupled, and both ends of the rear end and the rear case end wall 30 of the left and right case side walls 28 are coupled to each other, so that a rectangular frame shape is formed. Between the left and right case side walls 28, an inner cross member 32 extending in the left-right direction and having both ends coupled to the case side wall 28 is disposed. In the illustrated battery pack 16, there are four inner cross members 32. Battery stacks 18 are disposed between adjacent inner cross members 32, and between the rearmost inner cross members 32 and the rear case end walls 30. Thus, the battery case 20 houses four battery stacks 18.

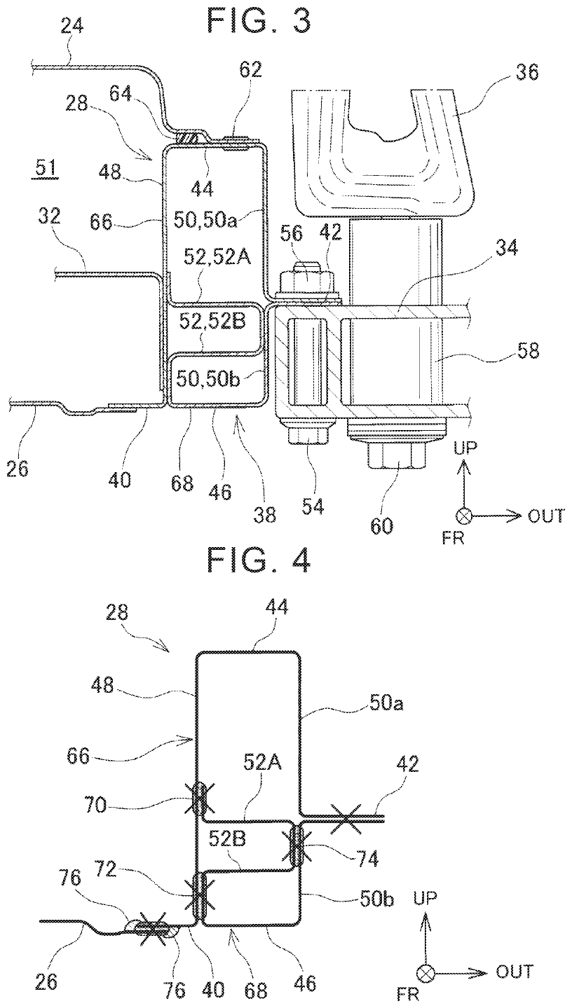

A shock absorber 34 is disposed on the vehicle width direction outer side of the frame 22. The shock absorber 34 is coupled to the case side wall 28 by fastening components such as bolts and nuts. The shock absorber 34 is structured to receive a collision load from the side when electrified vehicle 10 is laterally collided. Further, the shock absorber 34 is deformed by the received load, absorbs the collision energy, and reduces the load applied to the battery pack 16. The shock absorber 34 is disposed so as to extend along the front-rear direction, and has an outer shell portion having a closed cross section having a substantially quadrangular cross section orthogonal to the front-rear direction, and at least one partition wall that partitions the inner space of the outer shell in the left-right direction. The shock absorber 34 may be formed by extruding aluminum. The battery pack 16 is suspended and supported on the floor 14 via the shock absorber 34. The shock absorber 34 is fixed to a rocker 36 (see FIG. 3) located on the left and right side edges of the floor 14 by bolts, and the battery pack 16 is fixed below the floor of electrified vehicle 10.

FIG. 3 is a view showing a cross section orthogonal to the front-rear direction of the configuration of the case side wall 28 and the periphery thereof of the battery pack 16. The case side wall 28 has a tubular portion 38 having a generally rectangular closed cross-sectional structure, an inner flange 40 extending from the tubular portion 38 toward the vehicle width direction inner side, and an outer flange 42 extending from the tubular portion 38 toward the vehicle width direction outer side. As will be described later, the outer flange 42 is formed by stacking two steel plate members. The tubular portion 38 has an upper wall 44 corresponding to an upper side of a quadrangle having a cross-sectional shape, a lower wall 46 corresponding to a lower side, an inner wall 48 corresponding to an inner side in the vehicle width direction, and an outer wall 50 corresponding to an outer side in the vehicle width direction. The inner wall 48 directly faces the space for accommodating the battery stack 18, that is, the battery accommodating space 51 of the battery case 20.

A reinforcing wall 52 is disposed in the inner space surrounded by the tubular portion 38. The reinforcing wall 52 extends along the front-rear direction over the entire length of the case side wall 28. The reinforcing wall 52 may be disposed in a plane orthogonal to the vertical direction. An inner edge in the vehicle width direction of the reinforcing wall 52 reaches the inner wall 48, and an outer edge in the vehicle width direction reaches the outer wall 50. The battery case 20 includes two reinforcing walls 52. The upper reinforcing-wall 52A is arranged at the same height position as the outer flanges 42 on which the steel plates are stacked, that is, at the same position in the up-down direction. The lower reinforcing wall 52B is located approximately centrally between the upper reinforcing wall 52A and the lower wall 46. One reinforcing wall 52 may be disposed, and three or more reinforcing walls may be disposed. The uppermost reinforcing wall 52 is located at the same level as the outer flange 42.

The inner flange 40 is erected on the inner wall 48 and extends in the vehicle front-rear direction over the entire length of the case side wall 28. The inner flange 40 may be located at the lower edge of the tubular portion 38. The outer flange 42 is erected on the outer wall 50 and extends in the vehicle front-rear direction over the entire length of the case side wall 28. In particular, the outer flange 42 may be positioned between the upper edge and the lower edge of the outer wall 50.

The outer flange 42 is fastened to the upper surface of the shock absorber 34 by a bolt 54 and a nut 56. A portion of the case side wall 28 below the outer flange 42 faces the shock absorber 34. Further, a circular tube-shaped collar 58 is fixed to the shock absorber 34 by welding or the like, and the shock absorber 34 is fixed to the lower surface of the rocker 36, which is one of the skeletal members of the vehicle body, by a bolt 60 extending through the collar 58 and a nut (not shown). Accordingly, the battery pack 16 is suspended and supported by the vehicle body.

The lower cover 26 is joined to the inner flange 40 by welding, bonding, or the like, and a gap between the lower cover and the inner flange is sealed. The upper cover 24 is coupled to the case side wall 28, in particular the upper wall 44 of the tubular portion 38. The upper cover 24 is coupled to the upper wall 44 by rivets 62. In addition, the upper cover 24 and the upper wall 44 are sealed between the upper cover 24 and the rivet 62 by a seal member 64 such as an adhesive on the inner side in the vehicle width direction. The seal member 64 is disposed over the entire length of the case side wall 28.

The case side wall 28 is formed of two members, a first member 66 and a second member 68, each of which is formed of a roll-formed steel plate. The first member 66 and the second member 68 extend over the entire front-rear direction of the case side wall 28. The second member 68 may be divided into a plurality of portions in the front-rear direction. The first member 66 forms a portion of the inner flange 40, the inner wall 48, the upper wall 44, the outer wall 50 above the location where the outer flange 42 is erected, and the outer flange 42. The first member 66 is formed into the illustrated shape by bending one steel sheet by roll processing. The second member 68 forms an outer flange 42, a part below the position where the outer flange 42 of the outer wall 50 is erected, a lower wall 46, and two reinforcing wall 52A,52B. The second member 68 is also formed into the illustrated shape by bending a single steel sheet by roll processing. Hereinafter, a portion of the outer wall 50 above the outer flange 42 is referred to as an “outer wall upper portion 50a”, and a lower portion thereof is referred to as an “outer wall lower portion 50b”.

A portion of the second member 68 is joined to the first member 66 in an overlapped manner, and the overlapped portion forms an outer flange 42 together with the first member 66. In addition, the second member 68 is joined by being overlapped with a portion of the inner wall 48 at a portion between the portion forming the lower wall 46 and the portion forming the lower reinforcing wall 52B and a portion closer to the edge than the portion forming the upper reinforcing wall 52A. Further, the second member 68 is joined by being superposed on a portion forming its outer wall lower portion 50b at a portion between a portion forming the upper reinforcing wall 52A and a portion forming the lower reinforcing wall 52B.

By providing the reinforcing wall 52 at the same height position of the case side wall 28 as the outer flange 42 and at a position below the outer flange 42, the strength of the portion of the case side wall 28 facing the shock absorber 34 is increased. When a load due to a lateral collision is input from the shock absorber 34 to the case side wall 28, the collision load is received at a portion having a high strength, and deformation of the case side wall 28 is suppressed. Further, the thickness of the second member 68 forming the case side wall 28 may be greater than the thickness of the first member. Accordingly, the strength of the portion of the case side wall 28 facing the shock absorber 34 can be increased.

FIG. 4 is a schematic view illustrating an example of a bonding mode of the first member 66 and the second member 68 forming the case side wall 28. In the figure, the cross indicates the position of the spot weld, the shaded oval portion indicates the portion to be joined by the adhesive, and the hatched semicircular portion indicates the pre-cure seal portion.

The first member 66 and the second member 68 are joined by spot welding at a portion forming the outer flange 42. The joints 70, 72 of the inner wall 48 and the second member 68 are joined by adhesive and spot welding. In addition, the second member 68 is superposed on itself in the outer wall lower portion 50b and is joined by adhesive and spot-welding (joint 74). Further, the inner flange 40 of the first member 66 and the lower cover 26 are joined to each other by spot welding with an adhesive. The adhesive is applied over the entire length of the inner flange 40. In addition, along the edge of the inner flange 40 and along the edge of the lower cover 26, a pre-cure sealer 76 is applied over the entire length of the inner flange 40 and cured in a subsequent heating step to seal between the inner flange 40 and the lower cover 26.

The first member 66 of the case side wall 28 is seamlessly continuous in the portion of the upper wall 44 that is sealingly coupled to the upper cover 24, and more specifically, from the portion in contact with the seal member 64 to the inner flange 40 via the inner wall 48, and no hole is formed in this portion. Accordingly, even if water enters the inner of the tubular portion 38 through a hole for passing the rivet 62 formed in the upper wall 44 or a gap between the first member 66 and the second member 68 of the portion of the outer flange 42, the water is prevented from entering the first member 66 and further entering the internal space of the battery case 20 containing the battery stack 18.

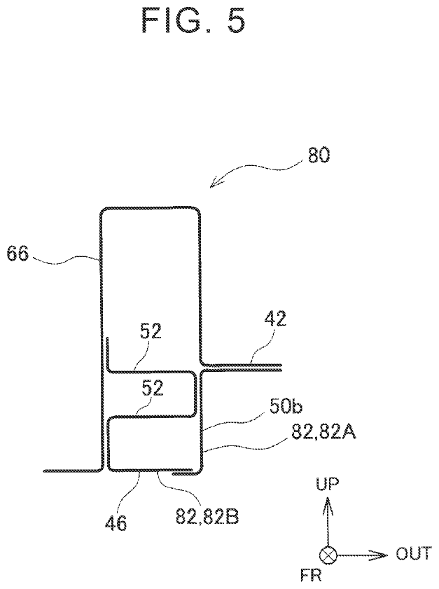

FIG. 5 is a view illustrating a case side wall 80 according to another embodiment. The case side wall 80 differs from the case side wall 28 in the aspect of the second member 82 corresponding to the second member 68. The second member 82 of the case side wall 80 has the same general configuration as the second member 68, but is composed of two component 82A,82B each formed from a separate steel plate. One component 82A forms an outer flange 42 and an outer wall lower portion 50b, and the other component 82B forms a lower wall 46 and a reinforcing wall 52. Both the component 82A,82B may be formed by roll-forming a steel sheet. As yet another aspect of the case side wall, the outer flange 42, the outer wall lower portion 50b, and the lower wall 46 may be formed in one member and the reinforcing wall 52 may be formed in another member.

What is claimed is:

1. A case side wall of a battery case of an in-vehicle battery, the case side wall comprising:
a tubular portion with a closed cross-sectional structure, made up of an upper wall, an inner wall, an outer wall, and a lower wall; and
an inner flange that is disposed along a longitudinal direction of the tubular portion and is erected on the inner wall, and that is sealingly joined to a lower cover of the battery case, wherein the case side wall includes a first member made of one steel plate that integrally and seamlessly makes up a portion of the upper wall that is sealingly joined to an upper cover of the battery case, the inner flange, and a portion from an upper edge of the inner wall to an erect portion of the inner flange, without a hole.

2. The case side wall according to claim 1, wherein
the case side wall further includes an outer flange that is disposed along the longitudinal direction of the tubular portion and is erected at a position between an upper edge and a lower edge of the outer wall, and that is joined to a structure located on a side of the battery case,
the first member further makes up the outer flange, and a portion of the outer wall from the upper edge to an erected portion of the outer flange,
the case side wall further includes a second member that is made of a steel plate, and that makes up a portion of the outer wall from the erected portion of the outer flange to the lower edge, and the lower wall, and
a portion of the second member overlaps with the first member to make up the outer flange together with the first member.

3. The case side wall according to claim 1, wherein the inner flange is erected at a lower edge of the inner wall.
